(19) United States
(12) Patent Application Publication
(10) Pub. No.: US 2003/0027028 A1
(43) Pub. Date: Feb. 6, 2003

(54) Metal-cored bipolar separator and end plates for polymer electrolyte membrane electrochemical and fuel cells

(76) Inventor: Herbert John Davis, Beaconsfield (CA)

Correspondence Address: OGILVY RENAULT, 1981 MCGILL COLLEGE AVENUE, SUITE 1600, MONTREAL, QC, H3A2Y3, CA

(21) Appl. No.: 09/906,715

(22) Filed: Jul. 18, 2001

(51) Int. Cl. H01M 8/02; H01M 8/24

(52) U.S. Cl. 429/34; 429/32

(57) ABSTRACT

Methods of treating the surface of metals, such as aluminum, so that they can withstand the corrosive conditions in polymer electrolyte membrane, including those types known as proton exchange membrane, (PEM), fuel cells and similar electrochemical environments and still maintain a high level of electrical and thermal conductivity over extended periods of time, are disclosed. A conductive polymer outer layer used in combination with an intermediate layer between the conductive polymer and a core metal, that comprises a thin layer of silver, or other noble metal, at the interface between the conductive polymer and an underlying metal layer, are compatible with the requirements of PEM fuel cells. Such treated metals can be formed into bipolar plates or end plates after receiving the coatings, or the conductive polymer layer can be applied or shaped into specifically required forms, alternatively the core metal can be previously formed into the required physical form and then treated on its surfaces so as to realise the benefits of this invention.

### BACKGROUND OF THE INVENTION

a) Field of the Invention

This invention relates to a bipolar plate for electrochemical and fuel cells, and to such cells incorporating a bipolar plate of the invention.

b) Description of Prior Art

Traditionally, bipolar separators for polymer electrolyte membrane fuel cells have been fabricated from graphite or carbon. These materials are primarily chosen for their resistance to degradation under the operating conditions of the cell, however, prefabricated sheets of carbon and/or graphite, consisting of essentially pure carbon, tend to be expensive and difficult to machine. Combining graphite or carbon powder with suitable thermosetting or thermoplastic polymers so as to make a conductive and more easily formable material usually compromises the thermal and electrical conductivity of the finished bipolar plate. Thin flow field plates are necessary when high volumetric and gravimetric energy densities are required, as is the case for fuel cells needed for automotive or portable applications and when it is desirable to limit the amount of material in the bipolar plate for cost reasons. Thin flow field plates, having limited conductivity, can result in uneven current distribution and voltage over the area of the membrane electrode assembly, (MEA), such that some areas will be supporting much higher current densities than others will and thus be subject to detrimental, localized heating. There are several approaches being taken to minimize this effect including improving the electrical conductivity in the plane of the flow field plate and increasing the thermal conductivity of the flow field plate.

As the thermal conductivity of most loaded, electrically-conductive polymers, as illustrated by the information included in table 1, is substantially less than the conductivity of pure graphite and by a factor of at least ten less than aluminum, another approach to solving the thermal management issue is to actually pass a cooling fluid through the center of the bipolar plate.

TABLE 1

| | | Thermal |
|---|---|---|
| | | Conductivity |
| Material | Reference Source | Watts/cm.K |
| Aluminum 1350-0 | MatWeb | 234 |
| Solid Graphite AWG | CRC Handbook 63^{rd} ed. | 80.7 |
| Parallel to | | |
| molding pressure | | |
| Solid Graphite AWG | CRC Handbook 63^{rd} ed. | 132 |
| Perpendicular to | | |
| molding pressure | | |
| Bipolar Plate | Independent determinations | 20 |
| Moldable Material A | | |
| Bipolar Plate | Independent determinations | 13.4 |
| Moldable Material B | | |

For low thermal conductivity plates, in order to keep the plate thickness down to acceptable levels, the use of forced, liquid cooling of the plates is essentially the only option. This is, however, far from ideal. The requirement for a separate cooling fluid circuit complicates the bipolar plate design and requires that the system have a separate heat management circuit. Making bipolar plates thin increases the risk that one or more of the cooling channels will become blocked, leading to the possibility of localized hot spots. Ensuring uniform flow over the whole plate area and over every plate in the stack is no simple matter, leading to a tendency to increase the circulation rates of the cooling fluid with a corresponding increase in parasitic (pumping) energy losses. Increasing the electrical conductivity of the flow field plate will reduce the variations in the current density over the whole plate, and will make the potential drop in all areas more nearly equal, thereby minimizing the heat related to the drop in local potential multiplied by the local current density.

It should be noted that the electrical conductivity of aluminum is some 500 times greater than that of graphite. As pointed out in Table 1 aluminum also has much better thermal conductivity than the currently available graphite replacement materials. For these reasons an aluminum flow field plate would be advantageous. Plain metallic aluminum, however, is not suitable due to its tendency to corrode in the cell environment and to form insulating oxide films. The inclusion of aluminum in the flow field plate would be beneficial, provided such a composite plate were stable in terms of its properties over the operating conditions and life of the cell.

Attempts to use metallic bipolar plates in PEM fuel cells are not new. C. E Reid et al, for example, reported at the 1988 Fuel Cell Seminar, November 16-19, Palm Springs Convention Center, California (published abstracts pp. 632-635) on their work to optimize metallic bipolar plates. They point out that even stainless steel has a bulk resistivity that is at least an order of magnitude lower than graphite, thus simplifying at least the issue of minimizing the voltage drop across the bipolar plate. The use of metallic plates, however, is complicated by the fact that their corrosion resistance is due to an oxide film, which can impede electron transfer, particularly when the metal comes into direct contact with the electrolyte film.

The possibility of using bipolar plates made out of aluminum is described in a patent issued to General Motors Corp., U.S. Pat. No. 5,624,769 “Corrosion resistant PEM fuel cell”. This patent describes a PEM fuel cell having electrical contact elements (including bipolar plates/septums) comprising a titanium nitride coated light weight metal core, having a passivating, protective metal layer intermediate the core and the titanium nitride. The combination of the protective layer and the titanium nitride is designed to overcome the fact that the titanium nitride is difficult to form pinhole free and that it is applied by an expensive process that takes a long time to build up suitable thicknesses of the titanium nitride. The underlying protective layer protects the core material in the areas where the pinholes would otherwise allow corrosion to occur. This patent mentions the use of electroless nickel as the protective layer.

There have also been reports in the open literature related to surface treatments for aluminum so as to render it suitable for use directly as the bipolar plate material in PEM fuel cells. A. S. Woodman et al of Physical Sciences Inc. for example have reported, in the 1999 Proceedings 6/21-24 of the American Electroplaters and Surface Finishers Society Annual Meeting on the use of gold layers on aluminum as a way of enabling aluminum to be used in such cells. The use of gold or other such noble and expensive metals requires that the coating be very thin, so as to control costs, and at the same time free from pinholes or other such defects. These two requirements are very difficult to manage, such that the use of perfect coatings of noble metals alone is not the preferred approach to being able to use aluminum as the base material for PEM bipolar plates.

As is taught in the British Application GB 0002865.4, published in Feb 2001, the use of an aluminum core allows intrinsically less conductive coatings to be used, provided the bond between the conductive polymeric coating and the aluminum is both intimate and electrically conductive and not subject to degradative corrosion.

We have found that direct application of a resin, containing a conductive filler, coating to aluminum offered some degree of protection to the aluminum, but the electrical resistance across the layer was found to increase with time of exposure to hot, humid air, rendering the total structure non-performant in terms of its potential use for bipolar plates.

Based on the prior work covered in U.S. Pat. No. 5,624,769, it was believed that the use of a layer of electro-less phosphorus-nickel on the aluminum would prevent corrosion and the formation of a non-conductive oxide on the surface of the aluminum, and allow the aluminum core to be used, once a secondary coat of corrosion resistant, conductive polymer had also been applied. The secondary coat would essentially serve the same function as the titanium nitride in the aforementioned patent, forming a passivating layer only in those regions where the secondary coating did not supply perfect protection to the underlying metal. It was discovered, however, that the resistance of the surface of the electro-less nickel quickly increased to unacceptable levels once the material was exposed to humidified air at temperatures of 90° C., rendering the use of such coating non-practicable.

### SUMMARY OF THE INVENTION

It is an object of this invention to provide improved bipolar plates for electrochemical and fuel cells.

It is a further object of this invention to provide electrochemical and fuel cells incorporating a bipolar plate of the invention.

It is a specific object of this invention is to provide a low cost coating that not only protects the aluminum from corrosion but also prevents the formation of a high resistance layer in the path of electrical conduction through the plate structure.

It is a further specific object of this invention to show how such junctions between coatings of a bipolar plate can be made to be of low resistance and exhibit true Ohmic behaviour.

It is a still further specific object of this invention to show how coatings can be applied to aluminum so as to render it both protected from corrosion and highly performant in terms of electrical conductivity as is required for application in PEM or electrochemical fuel cells.

In accordance with one aspect of the invention, there is provided a bipolar separator or end plate for electrochemical and fuel cells, comprising:

a core layer of a metal having high electrical and thermal conductivity,

an intermediate layer on the core layer comprising a noble metal layer, and

an outer cladding layer of conductive polymeric material that both bonds to the noble metal, and forms a stable, low resistance contact, and which affords corrosion protection to the core layer.

In accordance with another aspect of the invention, there is provided an electrochemical or fuel cell having therein a bipolar plate of the invention.

### DETAILED DESCRIPTION

The use of a highly electrically and thermally conductive material for a bipolar plate is considered to be essential if all of the bipolar plates in a fuel cell stack are to operate in quasi-equipotential and quasi-isothermal conditions over their full areas. It is not sufficient for the average resistance across the plate to be acceptable, as the average can be made up of localized areas supporting a very much higher current density than others and operating at a lower potential. This is due to voltage drops that can occur due to currents flowing in the bipolar plate from one area to another. This potential combination of high current and higher voltage drop can lead to localized heating. Localized heating will lead to locally higher temperatures giving rise to even higher local currents, consequently aggravating the effect, leading to dry out of the membrane and possible local failure.

The effect can be compensated by improved thermal and electrical conductivity in the plane of the plate, i.e. perpendicular to the direction of the required current flow. This parameter does not appear to have received much attention in the quest for a low cost, thin bipolar plate having adequate conductivity in the direction across it, i.e. from the anode to the cathode side. Even with pure graphite bipolar plates, the electrical and thermal conductivities are probably insufficient to prevent this effect when very thin plates are required. It has been found that the use of a metal with high electrical and thermal conductivity, such as aluminum, with an electrical conductivity some 500 times higher and a thermal conductivity double that of graphite, can contribute to greatly reducing this effect.

Based on the above, it would be desirable to have bipolar plates consisting of a core layer of aluminum, or similarly highly conductive metal such as magnesium, copper, steel or titanium, clad with and bonded to molded, conductive plastic layers that are inert to the environment of the cell, and which define the required flow fields.

This invention provides a means of formulating coatings on metals, such as aluminum, that allow bipolar plates, having cores of such metals, to be used in PEM fuel cells and electrochemical cells. More specifically the invention defines the nature of the interface required between an outer coat of a protective conductive polymer and a metallic layer that is pre-formed on the underlying metal core.

It has been found that certain types of protective coating applied to aluminum and exposed to humidified air at temperatures of 90° C., did not show the same degree of increase in surface resistivity. Sample coatings showing this type of performance included:

zincated aluminum plus electro-deposited nickel

zincated aluminum plus electro-deposited lead

zincated aluminum plus co-electrodeposited lead-tin

zincated aluminum plus electrodeposited nickel and tin

All of these coatings, when applied to 1 mm thick aluminum sheets and exposed to humidified air at 90° C., gave low surface resistance values over extended periods of time, when the resistance was measured between two metal electrodes with a layer of carbon cloth inter-spaced between the sample and each of the metal electrodes. Similar measurements that were taken with electro-less nickel did not show such stability, the resistance quickly increasing to unacceptable levels. Evaluation of the corrosion resistance of these coatings in a weak solution containing both fluoride and sulphate ions at 60° C., simulating the nature of the water emitted from PEM fuel cells, however, indicated that the corrosion rates were too high for these coated plates to be used directly as is for PEM fuel cell bipolar plates.

It was expected that very acceptable coatings for aluminum bipolar plates could be formed by combining primary coatings of the above type with a secondary coating of a conductive polymer. The secondary coating serving to greatly restrict the access of water and ions to the metallic surface and thereby reduce the corrosion rate significantly. It was found, however, that such combinations did not give low resistance behaviour, particularly once the samples were exposed to humidified air at 90° C. for any length of time. In many cases the contact between the two layers showed non-Ohmic behaviour typical of the presence of a semiconducting or rectifying junction.

While silver is a protective metal in its own right, it has been found that only very thin layers of silver are required to render pre-coated aluminum able to be further coated with a conductive polymer that not only gives a highly conductive interface, but also enables the aluminum to resist exposure to the environmental conditions typically present in PEM fuel cells. This corrosion resistance is far superior to the corrosion resistance exhibited by aluminum coated only with preliminary layers and a final layer of silver, even if the final silver layer is relatively thick.

For certain types of bipolar plate, such as those described in British Application GB 0002865.4, the teaching of which are incorporated herein, the conductivity of the graphite/plastic layer does not have to be high, as long as the plastic layer is thin enough and sufficiently conductive to allow acceptable voltage drops at the average current density of the plate. Conductivity in the plane of the plate is provided by the metal core. According to the invention, there is provided a bipolar separator plate or end plate for electrochemical or fuel cells, comprising a core layer of a metal having high electrical and thermal conductivity and having oppositely facing surfaces and cladding layers mechanically bonded to each of the oppositely-facing surfaces, each cladding layer comprising an electrically-conductive polymer resistant to the electrochemical conditions to which it will be exposed and effective to protect the core layer from such conditions. The present invention has important benefits when applied to structures of this type.

a) Core Layer

The core metal is one having good electrical and thermal conductivity, especially preferred is aluminum or alloys of aluminum with their metals, especially such alloys in which aluminum is the major metal component. Other suitable core metals include magnesium and its alloys, copper, titanium and steel, however these latter metals are less attractive from a weight standpoint.

The invention is especially concerned with problems that arise with thin plates. In general, the plate thickness is related to its size and power rating, so thickness may vary significantly in between different applications. In general, the metal core of the plate will have a thickness of 1 to 4 mm depending on plate size and continuous power rating.

b) Intermediate Layer

The intermediate layer comprises a layer of a noble metal, for example, silver, gold, platinum or palladium, and preferably sliver. The noble metal layer suitably has a thickness of 1 to 40 microns, but preferably 1 to 10 microns. Thicknesses above 10 microns function satisfactorily but result in higher cost especially at thicknesses greater than 25 microns.

The noble metal layer is preferably thin since its prime function is to control the impedance at the layer interface, although it also has the ability to protect the core metal.

The noble metal layer is preferably employed in conjunction with the one or more layers disposed between the core metal layer and the noble layer. Such layer or layers facilitate forming a strong bond between the core metal and the noble metal layer while maintaining the required thermal and electrical conductivity in the plate. Such layer or layers may also provide a protective function for the metal core, against corrosion. This facilitates use of a thinner noble metal layer since it is then not necessary to rely on the protective characteristics of the noble metal layer.

Suitable layers include zincate and stannate layers and by way of example, there may be mentioned:

zincated aluminum plus electro-deposited nickel,

zincated aluminum plus electro-deposited lead,

zincated aluminum plus co-electrodeposited lead-tin, and

zincated aluminum plus electrodeposited nickel and tin.

Other suitable layers include metal plating layers, for example, electroplated or deposited layers of nickel, tin, lead, bismuth or indium, or co-platings or deposits of two or more of these metals.

Combinations of these two classes of layer can be employed.

Preferred intermediate layers employ a zincate or stannate layer on the metal core; an electro-deposited layer, for example nickel or tin on the zincate or stannate layer and the noble metal layer, for example silver, on the electrodeposited layer.

It will be understood that there may be more than one zincate or stannate layer, more than one electrodeposited layer and more than one noble metal layer.

Suitably, the intermediate layer has a thickness of 10 to 20 microns so as to ensure a reasonable coherent coating with a minimum of pin-holes. Thinner intermediate layers are more susceptible to pin-hole formation, while thicker layers offer increased corrosion protection, but also increase the cost. In general, the intermediate layer may be up to 40 microns in thickness.

c) Conductive Polymer

The conductive polymer further protects the metal core, as well as the intermediate layer while maintaining a conductive path across the plate under the operating conditions to be encountered by the plate in a fuel or electrochemical cell. The conductive layer is suitably a thermosetting or thermally cured polymer or resin, or a thermoplastic polymer or resin loaded with an electrically conductive material, for example, particulate carbon, particulate graphite or carbon fibers. It will be understood that the conductive layer is one resistant to the electrochemical and environmental conditions to which it will be exposed in an electrochemical or fuel cell, and effective to protect the core metal and intermediate layer from such conditions.

A further requirement of the conductive polymer is that it bonds well with the underlying noble metal layer. By way of example, there may be mentioned the commercially available thermoset phenol-formaldehyde resin loaded with particulate graphite, available from DuPont Electronic Materials and designated as product CB-050.

In general, the conductive polymer may comprise a thermosetting or thermally-cured polymer or resin; or a thermoplastic polymer or resin and which includes a conductive filler in power or particular form, for example, carbon or its allotropes, or silver or silver coated particles or other stable electrically and thermally conductive materials.

The conductive polymer layer preferably has a thickness of 10 to 50 microns when applied as a coating, for example, by a dip or spray process, but could be thicker, for example up to 4000 microns when it is a formed or molded layer.

### BRIEF DESCRIPTION OF THE DRAWINGS

FIG. 1 is a fragmentary cross-section through the surface region of a bipolar separator plate in accordance with one embodiment of the invention;

FIG. 2 is a plot of test results displayed by bipolar plates having some but not all of the features of the invention; and

FIG. 3 is a plate similar to FIG. 2 but of bipolar plates in accordance with the invention.

### DESCRIPTION OF THE PREFERRED EMBODIMENTS

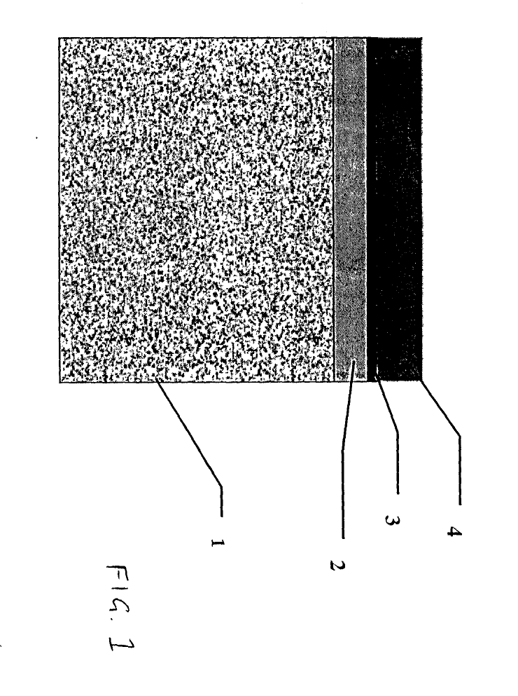

Exemplary embodiments of the invention will now be described with reference to FIG. 1, which is not drawn to scale, and only shows a cross sectional fragment of a plate.

In FIG. 1, (1) refers to base or core metal used for the plate. This can advantageously be aluminum due to the conductive and mechanical properties of this metal and its low cost. (2) is a plated layer formed on the metal core. It can consist of more than one layer and each layer can have more than one component. (3) refers to a silver or other noble metal layer that has to be included in the structure in order to realise the benefits described in this invention. This layer (3) can be very thin as its function is to control the impedance of the interface and is not specifically related to protecting the core metal (1) and its intermediate layers from corrosion. (4) is a final layer of a conductive polymer, that serves to protect the structure from corrosion while maintaining a conductive path across the plate under the operating conditions to be encountered in the cell.

As is well known for bipolar plates, the plates will typically have external surfaces configured with ridges and channels to define the flow fields.

This configuration of ridges and channels may be formed in the outer cladding layer of conductive polymeric material; or the metal core layer may be configured with ridges and channels, so that the coated layers on the core layer conform to the ridges and channels of the core layer, whereby the external surfaces define the required flow fields.

The ridges and channels may also be conjointly pressed to form said ridges and channels, with ridges on one external surface opposed to channels in an opposite external surface.

It will be recognized that opposed faces of the layer will each bear an intermediate layer and outer cladding layer in the case of a separator plate; and that any one surface of the core layer may bear an intermediate layer and an outer cladding layer in the case of an end plate.

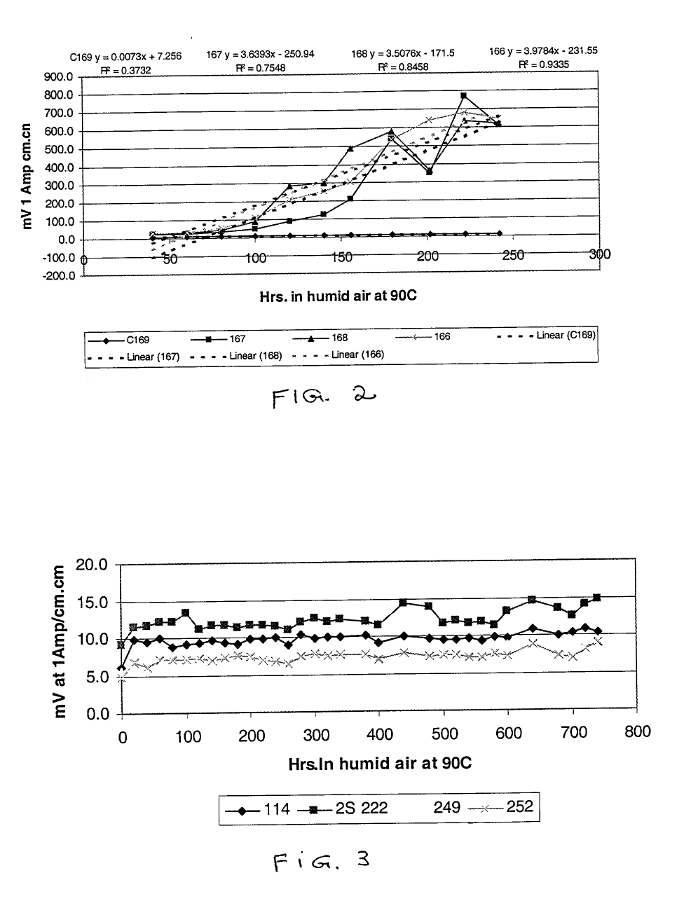

FIGS. 2 and 3 show graphically test results for bipolar plates having some features of the invention, and bipolar plates in accordance with the invention, respectively.

The examples presented below are only representative of the results obtained through application of the invention. Numerous other combinations of core metals and of plating sequences are not specifically mentioned, but are obvious to anyone experienced in the art of protective coatings.

### EXAMPLES

### Example 1

A sheet sample, 1 millimeter thick, of type 3003-H14 aluminum was first subjected to a zincate conversion treatment of its surface and then was electro-plated with nickel and finally with tin. This plate, designated as number 117, was exposed to humidified air at 90° C. for several hundred hours. The voltage drop across this plate when a current of 1 Amp/square cm. was passed through it went from 23 mV to 49 mV over a period of 500 hours. A similarly plated sample, but with an additional 10 microns of silver as the final layer, designated as number 251, had a much lower voltage drop under the same conditions, the value going from 1 mV to 2.5 mV over five hundred hours.

Additional sample plates of the above types were additionally coated with a thermosetting, conductive polymer material, supplied commercially by DuPont Electronic Materials and designated as product CB-050. Plate numbers 166, 167, 168 are similar in terms of the preliminary coatings to plate number 117. These plates were coated with the CB-050 material and then exposed to humidified air at 90° C. for several hundred hours. All of the plates showed a rapid increase in resistance, the voltage drop at 1 ampere per square centimeter increasing from an initial value of approximately 30 mV to above 700 mV after a period of 250 hours. These results are shown in FIG. 2 for “plates not embodying the invention”. This is in sharp contrast to plate number 249 that embodies the teaching of this invention and which is otherwise similar to plate number 251, but with the addition of a layer of silver prior to the application of the CB-050 secondary coating. The behaviour of this plate is shown FIG. 3 which has the results for “plates embodying the invention” and shows an initial voltage drop of about 12 mV and after 600 hours of exposure to the hot, humid air the voltage drop is essentially the same.

Corrosion measurements of plates embodying the invention were also undertaken. Plates were exposed to an electrolyte containing both sulphate and fluoride ions at 60° C. and the corrosion current was observed over a period of twelve hours with the sample potential being held at 700 mV with respect to the normal hydrogen electrode. Corrosion currents for plates corresponding to plate

Number 249, comprising a zincated aluminum sheet, subsequently plated with nickel, tin and silver and then coated with a layer of the CB-050 material showed corrosion currents corresponding to about 8×10⁻⁷ amperes per square centimeter.

### Example 2

A series of aluminum plates, of the type used in example 1, were zincated and then plated with nickel. Different plates from this series were then coated with either nominally 10, 5 or 1 micron of silver.

Each of these plates was evaluated for their corrosion behaviour in the fluoride and sulphate electrolyte at 60° C.

Corrosion currents after twelve hours were measured as follows:

| | |
|---|---|
| Nickel10 microns silver (plate #220) | 5.5 × 10⁻⁶ Amp/cm² |
| Nickel-5 microns silver (plate #108) | 2.5 × 10⁻⁵ Amp/cm² |
| Nickel-1 micron silver (plate #295) | 4.5 × 10⁻⁵ Amp/cm² |

None of the corrosion currents observed for the above plates are considered to be sufficiently low for long term use in operating fuel cells.

Plates of the above types having layers of either 10, 5 or 1 micron of silver were subsequently coated with CB-050. Similar corrosion current measurements were conducted on these samples. Corrosion currents after twelve hours showed improvements and were measured as follows:

| | |
|---|---|
| Nickel-10 microns silver-CB-050 (plate #218) | 2 × 10⁻⁶ Amp/cm² |
| Nickel-5 microns silver-CB-050 (plate #113) | 1.3 × 10⁻⁶ Amp/cm² |
| Nickel-1 micron silver-CB-050 (plate #296) | 2.5 × 10⁻⁵ Amp/cm² |

All of these plates exhibited low voltage drops at applied current densities of 1 Amp per square centimeter. This combination of low electrical resistance and corrosion resistance is an essential consequence of the thin silver or noble metal interfacial layer.

The ability to achieve the required low resistance and exceptional corrosion resistance is further exemplified in the next set of examples.

### Example 3

1 mm thick plates of type 3003-H14 were zincated and then plated with layers of nickel, tin and finally different thicknesses of silver. The resulting plated sheets were then coated with conductive polymers of various types.

These plates all showed low, stable voltage drops at current densities across the sheets of 1 Ampere per square centimeter even after prolonged exposure to high humidity air at 90° C. Even with very thin silver layers there was no evidence of passivation or increase in resistance due to extended exposure to these hot, humid conditions These plates also exhibited exceptionally low corrosion currents, even for the plates with only extremely thin intermediate silver coatings. Corrosion currents, under the conditions previously reported, were as follows:

| | |
|---|---|
| Nickel-tin-10 microns silver-CB-050 (plate #245) | 3.5 × 10⁻⁷ Amp/cm² |
| Nickel-tin-5 microns silver-CB-050 (plate #614) | 3 × 10⁻⁸ Amp/cm² |
| Nickel-tin-1 micron silver-CB-050 (plate #296) | 2.0 × 10⁻⁸ Amp/cm² |

While the above examples exhibit the basic findings of the invention, they are by no means intended to define the total extent of the potential application of the invention. Alternate base metals, intermediate-plated layers and conductive polymers could also be used in conjunction with the thin silver or noble metal interfacial layer.

1. A bipolar separator or end plate for electrochemical and fuel cells, comprising:
a core layer of a metal having high electrical and thermal conductivity, an intermediate layer on said core layer comprising a noble metal layer, and
an outer cladding layer of conductive polymeric material that both bonds to the noble metal layer, and forms a stable, low resistance contact, and which affords corrosion protection to the core layer.

2. A bipolar plate according to claim 1 in which the noble metal is silver in a thickness range from 0.1 microns to 40 microns.

3. A bipolar plate according to claim 2 wherein the noble layer has a thickness of 0.1 to 10 microns.

4. A bipolar plate according to claim 1 wherein the core layer is of a metal selected from aluminum, magnesium, copper, steel or titanium or alloys thereof.

5. A bipolar plate according to claim 4 wherein said intermediate layer further includes a layer selected from zincated or stannated layer between said core layer and said noble metal layer.

6. A bipolar plate according to claim 5 wherein said layer between said core layer and said noble metal layer is a zincated layer selected from the group consisting of
zincated aluminum plus electro-deposited nickel
zincated aluminum plus electro-deposited lead,
zincated aluminum plus co-electrodeposited lead-tin, and
zincated aluminum plus electrodeposited nickel and tin.

7. A bipolar plate according to claim 6 wherein said intermediate layer further includes at least one plated metal layer between said zincated layer and said noble metal layer.

8. A bipolar plate according to claim 7 wherein aid at least one plated metal layer comprises an electroplated or deposited layer of nickel, tin, lead, bismuth or indium.

9. A bipolar plate according to claim 8 wherein said intermediate layer has a thickness of 10 to 20 microns.

10. A bipolar plate according to claim 1 in which the outer cladding layer comprises a thermo-setting or thermally-cured polymer or resin.

11. A bipolar plate according to claim 1 in which the outer cladding layer comprises a thermo-plastic polymer or resin.

12. A bipolar plate according to claim 10 in which the polymer or resin comprises carbon, or its allotropes, in powder or particulate form as conductive filler.

13. A bipolar plate according to claim 11 in which the polymer or resin comprises carbon, or its allotropes, in powder or particulate form as conductive filler.

14. A bipolar plate according to claim 10 in which the polymer or resin comprises silver or silver coated particles, or other stable metal materials in powder or particulate form as conductive filler.

15. A bipolar plate according to claim 11 in which the polymer or resin comprises silver or silver coated particles, or other stable metal materials in powder or particulate form as conductive filler.

16. A bipolar separator plate according to claim 1, wherein external surfaces of the outer cladding layers are configured with ridges and channels so as to define flow fields therein.

17. A bipolar separator plate according to claim 1, wherein the core layer is configured with ridges and channels and then covered with the intermediate and outer cladding layers conforming to the ridges and channels in the core layer such that the required flow fields are defined on the surfaces of the bipolar plate.

18. A bipolar separator plate according to claim 1, wherein the core and cladding layers are conjointly pressed to form said ridges and channels, with ridges on one external surface opposite channels in an opposite external surface.

19. A bipolar separator plate according to claim 1.

20. A bipolar end plate according to claim 1.

21. In an electrochemical or fuel cell having a bipolar separator plate, the improvement wherein said plate is as defined in claim 19.

22. In an electrochemical or fuel cell having a bipolar end plate, the improvement wherein said end plate is as defined in claim 20.
